(19) United States
(12) Patent Application Publication
(10) Pub. No.: US 2026/0279815 A1
(43) Pub. Date: Sep. 17, 2026

(54) SOLVENT-FREE FABRICATION OF LITHIUM-ION BATTERY ELECTRODES USING POLYIMIDE-BASED BINDERS

(71) Applicant: SABIC Global Technologies B. V., Bergen OP Zoom (NL)

(72) Inventors: Tayirjan Taylor ISIMJAN, Geleen (NL); Antonios DOUFAS, Sugar Land, TX (US); David WEST, Sugar Land, TX (US)

(73) Assignee: SABIC Global Technologies B. V., Bergen OP Zoom (NL)

(21) Appl. No.: 19/168,095

(22) PCT Filed: Mar. 1, 2024
(86) PCT No.: PCT/EP2024/055461

§ 371 Date: Sep. 23, 2025

(30) Foreign Application Priority Data
Mar. 24, 2023 (EP) 23164110.1

(51) Int. Cl. H01M 4/62; H01M 4/02; H01M 4/04; H01M 4/131; H01M 4/134; H01M 4/136; H01M 4/1391; H01M 4/1395; H01M 4/1397; H01M 4/38; H01M 4/505; H01M 4/525; H01M 4/58; H01M 10/0525; H01M 10/058

(52) U.S. Cl. CPC H01M 4/622; H01M 4/0409; H01M 4/0435; H01M 4/131; H01M 4/134; H01M 4/136; H01M 4/1391; H01M 4/1395; H01M 4/1397; H01M 4/382; H01M 4/387; H01M 4/505; H01M 4/525; H01M 4/582; H01M 4/5825; H01M 4/625; H01M 10/0525; H01M 10/058; H01M 2004/021; H01M 2004/027; H01M 2004/028

(57) ABSTRACT

A solvent-free lithium-ion battery (LIB) electrode production process is disclosed. The electrode production process employs polymeric binder materials that are distinct from the conventional polyvinylidene difluoride binders. A powder coating process can be used to manufacture the LIB electrodes. The powder coating process avoids the use of a solvent, which in turn reduces overall production costs and improves production worker safety.

### CROSS-REFERENCE TO RELATED APPLICATIONS

This application claims priority to European Patent Application No. EP23164110 filed Mar. 24, 2023; the entire contents of which are incorporated herein by reference.

### A. Field of the Invention

This disclosure relates generally to lithium-ion battery electrodes and solvent-free methods for making lithium-ion battery electrodes.

### B. Description of Related Art

One step in the lithium-ion battery (LIB) manufacturing process is the coating of electrochemically active material on the surface of electrically conductive metal foil to create the electrode. The active material includes electrochemically active components that allow the electrode to cyclically store and release energy. In conventional LIB production methods, the active material is mixed with an organic solvent to form a slurry that is coated on the surface current collector sheets. The electrodes are then dried and calendered, a pressing process that improves adhesion and coating uniformity, and decreases the active material's porosity, thereby leading to an increase in energy density. The drying process is costly in being both energy and time-intensive, with some electrodes taking 12-24 hours to dry completely.

The active material slurries are generally prepared using per- and poly fluorinated substances (PFAS) as binders. Examples of PFA substances include polyvinylidene fluoride (PVDF), polytetrafluoroethylene (PTFE), and the like. There are a number of disadvantages related to the use of these materials as binders. For example, Schalicke et al. (Energy Technol. 2020, 8, 1900309) employed various polyfluorinated binders for powder coating anodes and observed adhesive strengths far below the corresponding values of convention wet-processed anodes. Furthermore, per- and poly fluorinated binders (e.g., PVDF) can slowly become dissolved in the battery electrolyte over time, thereby reducing the conducting linkage between the active material, conductive additives, and electrode current carriers. Furthermore, PFAS materials (e.g., PVDF and PTFE) are part of a class of compounds that have been termed “forever chemicals” due to their strong resistance to biological and chemical degradation. These chemicals are ubiquitous in today's society, and their negative impacts on human and ecosystem health are becoming more widespread.

The most commonly-used organic solvent in the dissolution and slurry preparation of PFAS is N-methyl-2-pyrrolidone (NMP), a toxic solvent that must be recovered and distilled for recycling. Evaporation of NMP during electrode drying requires a significant energy investment, as electrodes must be dried for several hours at temperatures as high as 120° C. Solvent recovery is used in commercial applications, because of NMP's high cost and toxicity, adding further costs to the LIB manufacturing process.

### SUMMARY OF THE INVENTION

Green alternatives such as solvent-free LIB production processes and eco-friendly binders could result in lower LIB production costs and minimized environmental impact. Aspects of this disclosure address at least some of the problems associated with polyfluorinated binders and slurry-based battery production methods. The solution is premised on employing dry electrode production methods and polymeric binder materials that are not based on polyfluorinated compounds. Dry electrode production processes, such as powder coating, reduce or avoid the use of toxic solvents and involve fewer preparation steps and equipment, thereby lowering overall capital and operational expenses. With less heavy equipment involved in powder coating, LIB electrodes can be manufactured using a fraction of the typical factory footprint. This also reduces the energy used for battery production. Furthermore, faster powder coating processes lead to higher manufacturing output while reducing costs and energy consumption. Further, the use of alternative polymeric binder materials is an environmentally friendly improvement over conventional polyfluorinated binder materials.

This disclosure is generally directed to powder coated electrodes, preferably powder coated LIB electrodes. In some embodiments, the electrode is a cathode, anode, or both. A powder coated LIB electrode apparatus can include an electrode and an active material disposed on the surface of the electrode. The active material can include an electrochemically active component and a binding compound for adhering the electrochemically active component to the electrode. In some embodiments, the electrochemically active component participates in an oxidation or reduction reaction to transport ions through an electrolyte for generating current through the electrode. In some implementations, the electrode is a secondary battery electrode. The electrode (apparatus) of the present invention can be used in one or more types of batteries. The type of battery can be determined from the electrochemically active component. For example, a lithium battery would have a lithium source as the electrochemically active component.

Non-limiting examples of the electrochemically active component include tin, lithium, cobalt, manganese, aluminum, tin, indium gallium, titanium, vanadium, chromium, iron, nickel, oxides thereof, phosphates thereof, fluorophosphates thereof, nitrides thereof, and combinations thereof. In further aspects, the active material further comprises an electrically conductive material. The binding compound can include polyimides, polyethyleneimines, polyesters, polyamides, polyurethanes, acrylics, polyolefins, polyvinylchloride, polystyrene, polyketones, copolymers thereof, and conjugated polymers, including n-type polymers and p-type polymers, or blends thereof, preferably, a polyimide, or a polyimide and polyester blend, more preferably a polyetherimide or a polyetherimide and polyethylene terephthalate blend. The binding compound can have a glass transition temperature (T_{g}) ranging from 50° C. to 250° C. Non-limiting examples of electrically conductive material include graphite, carbon, carbon black, acetylene black, carbon nanotubes, carbon nanoribbons, carbon fibers, carbon nanofiber, graphene, mesophase carbon microbeads, SnO₂, SnO, TiO₂, Li₄Ti₅O₁₂, LiTi₂O₄, SiO₂, silicon, germanium, coke, metal particles, or combinations thereof. In some aspects, the active material does not include per- and polyfluorinated substances such as polyvinylidene difluoride and polytetrafluorethylene. Each constituent component of the active material, including the binding compound, the electrochemically active component, and the electrically conductive material, can have an average particle size ranging from 1 μm to 30 μm, preferably from 5 μm to 15 μm. Each constituent component of the active material can have an average particle size that is any one of, less than, greater than, or between 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 μm, or any range derivable therein. Particle size can be measured using standard methodology or instrumentation (e.g., a laser diffraction particle analyzer). Standard methodology can include ASTM E3344-22 or ISO-13320:2020. Commercial sources of a laser diffraction particle analyzer include Horiba (Japan), Beckman Coulter Life Science (USA, e.g., a LS 13 320 XR particle analyser), and Malvern Pananalytical (United Kingdom). The active material can include from 60 to 98% by weight of the electrochemically active component, from 0 to 40% by weight of the electrically conductive material, and from 2 to 40% by weight of the binding compound. In some embodiments, the active material includes any one of, less than, greater than, or between 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, and 98% by weight of the electrochemically active component, or any range derivable therein. The active material can include any one of, less than, greater than, or between 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40% by weight of the electrically conductive material, or any range derivable therein. The active material can include any one of, less than, greater than, or between 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40% by weight of the binding compound, or any range derivable therein. In one aspect of the present invention, the active material can include 60 to 98% by weight of the electrochemically active component, from 0% to 20% by weight of the electrically conductive material, and from 2% to 40% by weight of the binding compound.

In some embodiments, a battery electrode can be produced by powder coating an outer surface of an electrode with an active material that includes an electrochemically active component and a binding compound for adhering the active material to the electrode. In some aspects, the battery electrode is a secondary battery electrode. In some embodiments, the electrode is a cathode, anode, or both. The binding compound can include polyimides, polyethyleneimines, polyesters, polyamides, polyurethanes, acrylics, polyolefins, polyvinylchloride, polystyrene, polyketones, copolymers thereof, and conjugated polymers, including n-type polymers and p-type polymers, and blends thereof, preferably a polyimide or a polyimide and polyester blend, more preferably a polyetherimide or a polyetherimide and polyester (e.g., poly(ethylene terephthalate), poly(butylene terephthalate)) blend. In various embodiments using a polyimide and polyester blend, it is possible to use a single polyester as the polyester component, such as poly(ethylene terephthalate) alone, or more than one polyester. In some embodiments, the binding compound comprises a blend of polyetherimide and poly(ethylene terephthalate). Each constituent component of the active material, including the binding compound, the electrochemically active component, and the electrically conductive material, can have an average particle size ranging from 1 μm to 30 μm, preferably from 5 μm to 15 μm. The binding compound can have a glass transition temperature (T_{g}) ranging from 50° C. to 250° C. The powder coating process can further comprise a hot pressing process a hot rolling process, or a combination thereof.

Some configurations of the present disclosure include a battery electrode, where the battery electrode is produced by a powder coating process. The powder coating process can include mixing the electrochemically active component and the binding compound that includes polyimides, polyethyleneimines, polyesters, polyamides, polyurethanes, acrylics, polyolefins, polyvinylchloride, polystyrene, polyketones, copolymers thereof, and conjugated polymers (including n-type polymers and p-type polymers) or blends thereof, to form the active material, and adhering the active material to the outer surface of the electrode in the absence of a solvent. In some implementations, the battery electrode is a secondary battery electrode.

In some embodiments, the method for manufacturing a battery electrode can include mixing an electrochemically active component, a binding compound that includes polyimides, polyethyleneimines, polyesters, n-type polymers, p-type polymers, or blends or copolymers thereof, and, optionally, an electrically conductive material, to provide an active material. Preferably, the binding compound includes a polyimide or polyimide and polyester blend. More preferably the binding compound is a polyimide and polyester blend. The active material can be adhered to an outer surface of an electrode. In some embodiments, the electrode is a cathode, anode, or both. Notably, the adhering process is performed in the absence of a solvent. Non-limiting examples of the adhering process can include a powder coating process, a hot-pressing process, a hot rolling process or a combination thereof. In some embodiments, the active material does not include polyvinylidene difluoride. In some embodiments, each constituent component of the active material has an average particle size ranging from 1 μm to 30 μm, preferably from 5 μm to 15 μm. In some implementations, the battery electrode is a secondary battery electrode. In some embodiments, the electrode is a cathode, anode, or both.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

A “p-type polymer” is a polymer having functional groups that create the effect of a positive charge in the absence of an electron. Examples of p-type polymers include polythiophenes and poly(p-phenylene vinylenes). An “n-type polymer” is a polymer with a high content of electron acceptor units that provide an excess of negatively charged carriers in polymeric backbones. Examples of n-type polymers include poly-naphthalene diimides, poly-perylene diimides, and poly-bisindenofluorenedicyanovinylenes. A “minimum film-formation temperature” is a characteristic temperature of a polymer below which it can no longer form a film. A “glass transition temperature” or “T_{g}” is a temperature at which an amorphous material or amorphous regions of a semicrystalline material undergo a transition from a rigid state to a more flexible state. When ambient temperature is below T_{g}, the molecular chains of an amorphous material (or amorphous regions of a semicrystalline material) are frozen in place and behave like a glass. When ambient temperature is above T_{g}, the molecular chains of an amorphous material (or amorphous regions of a semicrystalline material) are flexible and the material is bendable.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, which includes the component. In a non-limiting example, 10 grams of component in 100 grams of the material is 10 wt. % of component.

The term “substantially” and its variations are defined to include ranges within 10%, within 5%, within 1%, or within 0.5%.

The use of the words “a” or “an” when used in conjunction with any of the terms “comprising”, “including”, “containing”, or “having” in the claims, or the specification, may mean “one”, but it is also consistent with the meaning of “one or more”, “at least one”, and “one or more than one.”

The use of the word “apparatus” may mean “one”, but it is also consistent with the meaning of “one or more”, “at least one” and a plurality of apparatus (e.g., apparatuses). Apparatus and apparatuses can be used interchangeably.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The electrodes of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of electrodes of the present invention is their ability to be produced in the absence of a binder solvent and/or in the absence of polyvinylidene difluoride.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting the scope of the claims. Additionally, it is contemplated that changes and modifications within the scope of the claims will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIGS. 1A and 1B is a non-limiting example of a conjugated copolymer binder of the present invention. The binder includes unites of the n-type polymer bis-imino-acenaphthenequinone-paraphenylene (BP) and units of the p-type polymer poly(3,4-ethylenedioxythiophene) (PEDOT).

FIG. 2 is a diagram depicting a battery electrode production method, according to some embodiments of the present invention.

FIG. 3 is an illustration depicting a battery, according to some embodiments of the present invention.

FIG. 4 is an illustrations of the inventive cathode films (left film) having 70 wt % polyimide and 30 wt. % polyester after the copper film was removed (right film)

FIGS. 5A and 5B are illustrations of the inventive cathode films (left film in each FIG.) having various amounts of polyimide and polyester after the copper film was removed (right film in each FIG.). FIG. 5A includes 18 wt. % polyester and 82 wt. % polyimide and was hot pressed. FIG. 5B include 0 wt. % polyester and 100% polyimide and was hot pressed.

FIGS. 6A, 6B, 6C, and 6D are graphical illustrations of charge-discharge testing of at 0.2 C-rate (C) and 25° C. for an inventive apparatuses and a comparative apparatuses. The inventive apparatuses were made using dry methodology and the comparative apparatus was made using a conventional wet PVDF methodology and dry methodology. FIG. 6A is a graphical illustration of the charge-discharge test the inventive apparatus (ER-1 cell). FIG. 6B is a graphical illustration of the comparative apparatus (wet PVDF cell). FIG. 6C is a graphical illustration of the inventive apparatuses (ER-1 cell (solid line), ER-2 cell (dash & dot line) and PVDF-0 cell (two dots and dash line)) and the comparative apparatus (wet PVDF cell, dashed line). FIG. 6D is a graphical illustration of the inventive apparatus (ER-1 cell, (solid line)) and the comparative apparatus (wet PVDF cell (dashed line), dry PVDF-1 (2 dots and dash line), dry PVDF-2 (dot and long dash line), and dry PVDF-3 (dot and dash line)).

FIG. 7 is a graphical illustration of the charge-discharge profile at the second discharge-charge cycle at 0.1 C and 25° C. for the inventive apparatus (ER-1, solid line) and the comparative apparatus (wet PVDF, dotted line). The upward sloping lines are charging data and the downward sloping lines are discharging data.

FIG. 8 is a graphical illustration of the differential capacity analysis (dQ/dV) curves during the second discharge cycle at 0.1 C and 25° C. for the inventive apparatus (ER-1, solid line) and the comparative apparatus (wet PVDF, dashed line). The top lines are charge curves and the lines in the negative axis are discharge curves.

FIGS. 9A and 9B are EIS spectra of the inventive apparatus (ER-1, solid line) and the comparative apparatus (wet PVDF cell, dashed line) at 100% state of charge (SOC, FIG. 9A) and 0% SOC (FIG. 9B). Both spectra were performed at a frequency of 1M-4 Hz and an amplitude of 10 mV.

FIG. 10 depict Rᵢₘ−^{ω-0.5} plots for the inventive apparatus (ER-1, square monikers) and the comparative apparatus (wet PVDF, triangle monikers) at 0% SOC.

FIGS. 11A, 11B, 11C, 11D, 11E, and 11F depict C-rate and Cycling performance for the inventive apparatus (ER-1) and the comparative apparatus (wet PVDF). FIGS. 10A and 10B depict cell voltage vs. capacity plots for the inventive apparatus (ER-1) and the comparative apparatus (wet PVDF), respectively at 2 C, 1 C, 0.5 C and 0.2 C. FIGS. 10C and 10D depict capacity vs. cycle plots for the inventive apparatus (ER-1) and the comparative apparatus (wet PVDF), respectively. The open circle monikers are charge, the solid circle monikers are discharge, and the triangle monikers are efficiency. FIGS. 10E and 10F depict discharge capacity vs. C-rate plots for the inventive apparatus (ER-1, solid circle monikers) and the comparative apparatus (wet PVDF, open circle monikers), respectively. FIG. 10E is normalized charge capacity and FIG. 10F is discharge capacity (mAh/g).

While the invention is susceptible to various modifications and alternative forms, specific embodiments thereof are shown by way of example in the drawings. The drawings may not be to scale.

### DETAILED DESCRIPTION OF THE INVENTION

Commercial lithium-ion battery (LIB) electrodes are conventionally made by wet processes that involve the production of slurries. The slurries typically include metal oxide (cathode) or graphitic (anode) material, an electrically conductive filler material, and a polymeric binder in a solvent. The most commonly-employed solvent and binder used in electrode slurries are N-methyl-2-pyrrolidone (NMP) and polyvinylidene difluoride (PVDF), respectively. The slurries are kneaded into a paste and coated onto electrically-conductive current collector sheets. The solvent is removed and the dried electrode is calendared to provide flat electrode sheets. The use and subsequent removal of the solvent contributes significantly to the overall LIB production cost.

Processes that eliminate the slurry production and ensuing solvent removal steps, such as embodiments of a manufacturing process described herein, provide multiple advantages. Despite its widespread use in electrode production processes, NMP is a toxic compound that is hazardous to workers. Other solvents that dissolve PVDF, including tetrahydrofuran and dimethyl sulfoxide, are readily absorbed through the skin and are as toxic to LIB production workers as NMP. In addition to these health hazards, significant costs involved in the solvent drying and recovery process (~ $31 kW/h), could be eliminated if solvent use could be avoided.

PVDF binders make up approximately 2 to 5 wt. % of the entire weight of a typical LIB, however, PVDF cost and associated disposal/recycling fees represent a much larger fraction of the entire LIB cost. Over the years, many performance-related drawbacks associated with the PVDF binders have been reported, such as its dissolution in the electrolyte over long cycling, inability to maintain the conducting linkage between the active material and conductive additives, and inability to provide the required mechanical support to the active material. These drawbacks result in capacity fading, average cyclability, and increased cell resistance. Additionally, PVDF is very sensitive to environmental humidity. Like many fluorinated polymers at elevated temperatures, it shows a particular reactivity against lithium metal or lithiated graphite (C₆Li), producing sensitive species such as lithium fluoride and vinyl fluoride on the electrolyte surface, which can trigger the onset of thermal runaway. PVDF is part of a class of compounds that have been termed “forever chemicals” that are resistant to degradation and represent a significant environmental concern.

Embodiments described herein address at least some of the problems associated with conventional LIBs and their production methods. Some embodiments involve a solvent-free manufacturing method for the production of LIB electrodes. The solvent-free manufacturing method precludes the use of a solvent, thereby eliminating the costs associated with the solvent itself and with the energy-intensive solvent removal process. The solvent-free manufacturing method employs at least one of a powder coating process, a hot-pressing process, and a hot rolling process for adhering the active material components to the electrode. The electrode can be an electrode of a secondary battery, for example. In some embodiments, the electrode is a cathode, anode, or both.

Additionally, some methods disclosed herein employ an alternative polymeric binder in place of the commonly-employed PVDF binder. By eliminating or reducing the use of a solvent and replacing the binder with an alternative polymeric binder, embodiments disclosed herein are more environmentally friendly LIB electrode production process. The solvent-free LIB electrode manufacturing process disclosed herein can result in ~20% cost reduction and provide comparable or improved LIB performance. These and other non-limiting aspects of the present invention are discussed in further detail in the following sections.

### Electrochemically Active Component

The electrochemically active component can be a positive electrode active component. Non-limiting examples of positive electrode active components can include tin, lithium, cobalt, manganese, aluminum, tin, indium gallium, titanium, vanadium, chromium, iron, nickel, oxides thereof, phosphates thereof, fluorophosphates thereof, nitrides thereof, or alloys, or combinations thereof. In some embodiments, the electrochemically active component is at least one of LiCoO₂, lanthanum lithium titanium oxide (Li₃ₓLa_{2/3-x}TiO₃), lanthanum lithium zirconium oxide (Li₇La₃Zr₂O₁₂), L₁₀GeP₂S₁₂, LiNi_{1/3}Co_{1/3}Mn_{1/3}O₂, LiNi_{0.8}Co_{0.15}Al_{0.05}O₂, Li₁₊ₓNi_{1/3}Co_{1/3}Mn_{1/3}O₂, where 0<x<0.8, LiMn₂O₄, LiFePO₄, Li₂Mn₂O₄, LiNiCoAlO₂, LiNi_{y}CoₓM_{z}O, where M=Mn, Al, Sn, In, Ga or Ti and 0.15<x<0.5, 0.5<y<0.8 and 0<<0.15, Li[Li_{(1-2y)/3}Ni_{y}Mn_{(2-y)/3}]O₂, Li[Li_{(1-y)/3}Co_{y}Mn_{(2-2y)/3}]O₂ and Li[Ni_{y}Co_{1-2y}Mn_{y}]O₂, 0<y<0.5, LiNiCoO₂·MnO₂, lithium rich compounds Li_{1+y}(Ni_{1/3}Co_{1/3}Mn_{1/3})_{1-y}O₂, where y=x/(2+x) and X=0-0.33, and xLi₂MnO₃(1−x)Li(NiCoMn)O₂ and Li_{(1+y)}(Ni_{0.5}Co_{0.2}Mn_{0.3})_{1-y}O₂, where y=x/(2+x) and x=0-0.33, and LiMPO₄, where M is V, Cr, Mn, Fe, Co, Ni or combinations thereof. In aspects, when the apparatus is to be used in a lithium battery, the electrochemically active component includes a lithium compound. In one aspect, the electrochemically active component is NiₓCo_{y}Mn_{z}O₂, where x+y+z=1.0

In some embodiments, the electrochemically active component is a negative electrode active compound. In some aspects, the negative electrode electrochemically active component is capable of reversible intercalation and deintercalation of lithium. Non-limiting examples of the negative electrode active compound can include carbon, hard carbon, soft carbon, crystalline carbon (examples of which include amorphous, plate, flake, circular, or fiber natural graphite, or artificial graphite), amorphous carbon, synthetic graphite, mesophase carbon microbeads, mesophase pitch carbide, sintered cokes, SnO₂, SnO, TiO₂, Li₄Ti₅O₁₂, LiTi₂O₄, SiO₂ silicon, or mixtures thereof. The negative electrode electrochemically active component can be combined with a binding compound and, optionally, an electrically conductive material to provide a negative electrode active material.

The electrochemically active component can have an average particle size ranging from 1 μm to 30 μm, preferably from 5 μm to 15 μm. For example, the electrochemically active component can have an average particle size that is any one of, less than, greater than, or between 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 μm, or any range derivable therein. Particle size can be measured using standard methodology or instrumentation (e.g., a laser diffraction particle analyzer). Standard methodology can include ASTM E3344-22 and ISO-13320. Commercial sources of a laser diffraction particle analyzer include Horiba (Japan), and Malvern Pananalytical (United Kingdom).

### Binder Material

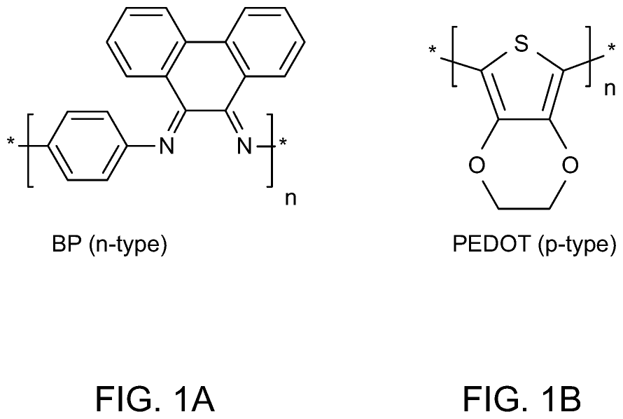

Non-limiting examples of binder material can include homopolymers or copolymers of polyimides, polyethyleneimines, polyesters, n-type polymers (FIG. 1A), p-type polymers (FIG. 1B), acrylic acid or methacrylic acid derivatives, polyamide, polyacrylamide, polyacrylonitrile, butyl acrylate-styrene copolymers, butyl acrylate-acrylonitrile copolymers, butyl acrylate-acrylonitrile-glycidyl methacrylate copolymers, polyisobutylene, isobutylene-isoprene rubber, isobutylene-styrene copolymers, polybutadiene, polyisoprene, butadiene-styrene random copolymers, isoprene-styrene random copolymers, acrylonitrile-butadiene copolymers, acrylonitrile-butadiene-styrene copolymers, butadiene-styrene-block copolymers, styrene-butadiene-styrene-block copolymers, isoprene-styrene-block copolymers, styrene-isoprene-styrene-block copolymers, dimethylpolysiloxane, diphenylpolysiloxane, dihydroxypolysiloxane, polyolefins including but not limited to polyethylene, polypropylene, poly-1-butene, ethylene-α-olefin copolymers, propylene-α-olefin copolymers, ethylene-propylene-diene copolymers (EPDM), ethylene-propylene-styrene copolymers, polyvinyl alcohol, polyvinyl acetate, polyvinyl stearate, and vinyl acetate-styrene copolymers, polyethylene oxide, polypropylene oxide, epichlorohydrin rubbers, poly(2-methoxyethoxyethoxyethylene), styrene butadiene rubber (SBR), butadiene-acrylonitrile, rubber (NBR), hydrogenated NBR (HNBR), epichlorohydrin rubber (CHR) and acrylate rubber (ACM), sodium alginate, polyurethane, ethylene propylene diene, carboxymethyl cellulose (CMC), methyl cellulose (MC), cellulose acetate phthalate (CAP), hydroxypropyl methylcellulose (HPMC), hydroxypropyl methylcellulose phthalate (HPMCP), styrene butadiene rubber (SBR) binders, bis-imino-acenaphthenequinone-paraphenylene or blends thereof, or copolymers thereof. Of these, polyimides or a blend of polyimides and polyesters are preferred binder materials. For example, polyetherimide or a polyetherimide (e.g., CAS No. 61128-24-3) and poly(ethylene terephthalate) (e.g., CAS No. 25038-59-9) blend, a polyetherimide and poly(butylene terephthalate) (e.g., CAS No. 24968-12-5) blend, or a polyetherimide, poly(ethylene terephthalate), poly(butylene terephthalate) blend. Non-limiting examples of a polyetherimide, a polyethylene terephthalate, and a polybutylene terephthalate are shown in Scheme I.

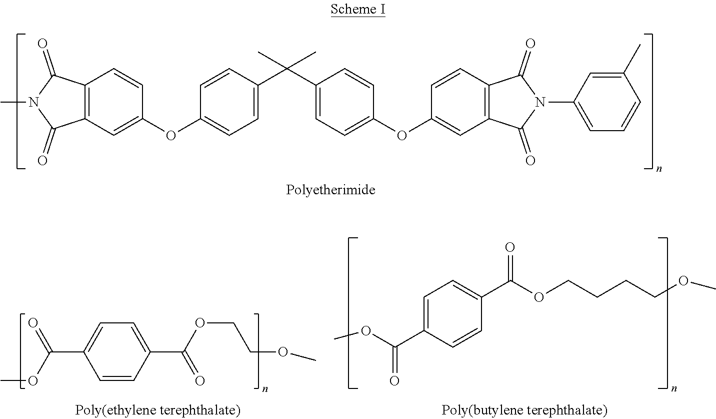

Polyetherimide can be purchased from commercial sources, for example sold by SABIC under the tradename Ultem®. Polyesters such as poly(ethylene terephthalate and poly(butylene terephthalate) (also referred to as PET and PBT, respectively) can be purchased from commercial sources. PET and PBT are very similar in properties, with PBT having a slightly lower glass transition temperature than PET. In some aspects of the present invention, the binder includes a minimum of 40 wt. % of the polyimide. For example, 40 wt. % to 100 wt. % or 40, 45, 50, 55, 60, 65, 70, 75, 80, 85, 90, 95 and 100 wt. % or any value or range there between of polyimide. The binder can include a maximum of 60 wt. % polyester material. For example, 0 wt. % to 60 wt. % or 0, 1, 5, 10, 15, 20, 25, 30, 35, 40, 45, 50, 55, 60 wt. % of polyester. In some aspects, the binder material includes 40 wt. % to 99.9 wt. % polyimide and 0.1 wt. % to 60 wt. % polyester. For example, 40, 45, 50, 55, 60, 65, 70, 75, 80, 85, 90, 95 and 99.9 wt. % or any value or range there between of polyimide 0.1, 1, 5, 10, 15, 20, 25, 30, 35, 40, 45, 50, 55, 60 wt. % of polyester. In other examples, the binder can 65 wt. % to 80 wt. % polyimide and 20 wt. % to 35 wt. % polyester. In another aspect, the binder can include 70 wt. % to 75 wt. % polyimide and 25 wt. % to 30 wt. % polyester.

In some aspects, the binder has a glass transition temperature (Tg) of 50° C. to 250° C. For example, the binding compound can have a glass transition temperature that is any one of, less than, greater than, or between 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, and 250° C., or any range derivable therein, or any range derivable therein. there between as measured by Differential Scanning calorimetry (DSC) at a rate of 10° C./min.

The binder material can have an average particle size that is similar to the electrochemically active material, the electrically conductive material or both. Having a similar particle size can allow the binder to evenly coat the electrochemically active material and/or the electrically conductive material. A binder particle size can range from 1 μm to 30 μm, preferably from 5 μm to 15 μm. For example, the binder material can have an average particle size that is any one of, less than, greater than, or between 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 μm, or any range derivable therein. Particle size can be measured using standard methodology or instrumentation (e.g., a Beckman LS 13 320 XR laser diffraction particle analyzer). Standard methodology can include ASTM E3344-22 and ISO-13320. Commercial sources of a laser diffraction particle analyzer include Horiba (Japan), and Malvern Pananalytical (United Kingdom).

### Electrically Conductive Material

In order to improve electrical activity, the active material can optionally include an electrically conductive material. Examples of electrically conductive material include carbon black, acetylene black, carbon nanotube, carbon nanofiber, carbon fibers, carbon powder, coke, high surface area carbon, graphite, metal-based materials such as metal powder and metal fiber that comprise copper, nickel, aluminum, or silver, for example, conductive polymers such as polyphenylene derivatives, and mixtures thereof. In one aspect, the electrically conductive material is acetylene black. The electrically conductive material can have an average particle size ranging from 0.01 μm to 30 μm, preferably from 0.01 μm to 15 μm. For example, the electrically conductive material can have an average particle size that is any one of, less than, greater than, or between 0.01, 0.02, 0.03, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 μm, or any range derivable therein. Particle size can be measured using standard methodology or instrumentation (e.g., a laser diffraction particle analyzer). Standard methodology can include ASTM E3344-22 and ISO-13320. Commercial sources of a laser diffraction particle analyzer include Horiba (Japan), and Malvern Pananalytical (United Kingdom).

### Methods

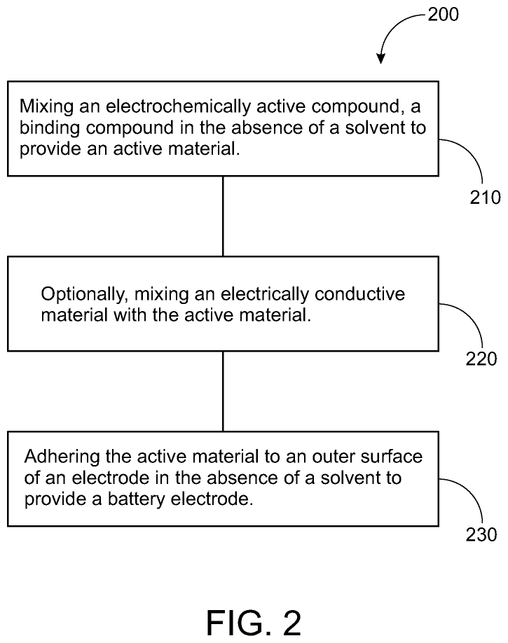

Embodiments of this disclosure may provide solvent-free or dry methods for producing LIB electrodes. Referring to FIG. 2, an example method 200 can include a first step 210 of mixing an electrochemically active component and a binder material in the absence of a solvent to provide an active material. In optional step 220, an electrically conductive material can be mixed with the active material. In step 230, the active material is adhered to an outer surface of an electrode using a powder coating process. The powder coating can further comprise a hot-pressing process, a hot rolling process, or a combination thereof.

To construct an electrode using a powder coating process, dry powders of an electrochemically active component, a binder and, optionally, an electrically conductive material are milled and/or mixed and coated onto the surface of electrically conductive metal foil electrode material. The powder coating process is an electrostatic spray deposition process whereby electrostatically charged active material particles are applied onto the surface of an electrode material. Each of the active material mixture components can be pre-milled or manufactured to a desired size prior to assembling the mixture. Non-limiting examples of milling include ball milling, cutter, bead milling, high-energy milling, cold milling, ultra-sonic milling, jet milling, spray drying, precipitation, emulsion polymerization, and the like.

Each of the active material components can be added at a desired ratio or proportion of the final mixture. The active material components can be mixed together in a drum, a hopper, or any suitable container prior to powder coating. Once the active material components are adequately mixed, the mixture can be transferred to a powder coating spray gun. The active material mixture can be applied to the surface of an electrode material through more than one powder coating spray gun. After the active material mixture is in the powder coating spray gun, a charge can be applied to the mixture in order to spray the active material mixture onto the electrode material surface. In some embodiments, the electrochemically active component, binder material and, optionally, an electrically conductive material can be separately applied to the electrode surface. When applied separately, the active material components can be applied sequentially, or simultaneously through a plurality of powder coating spray guns.

Some embodiments of this disclosure provide a dry electrode production process which circumvents the use of organic solvents and the negative health and environmental impacts associated with the harmful organic solvents. In addition, the present invention permits a wide variety of polymer binders to be used in battery electrodes. By selecting the polymer binder chemical structure, polydispersity, molecular weight, and other polymer properties, it is possible to tune the characteristics of the polymer binder to yield the desired results. The dry electrode production process disclosed herein can boost production throughput by eliminating the solvent addition and removal steps.

### Battery

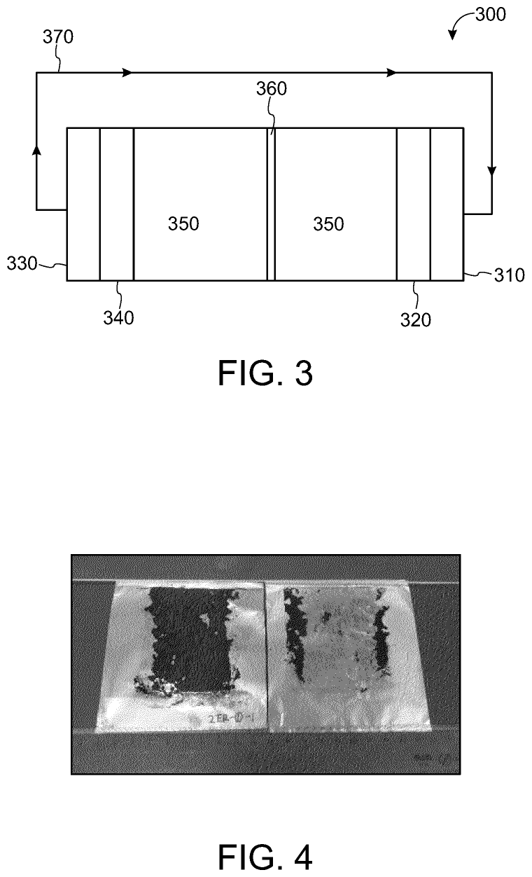

Embodiments of this disclosure may provide batteries comprising electrodes produced by solvent-free production methods. Referring to FIG. 3, a battery 300 of the present disclosure can include a cathode 310 and an anode 330. The cathode 310 includes an active material 320 provided on a surface of the cathode. The anode 330 includes an anode active material 340 on an anode surface that can include an electrically conductive material. An electrolyte 350 is provided between the cathode 310 and the anode 330. A separator 360 is in contact with the electrolyte 350 and is located between the cathode 310 and the anode 330. Electrons traveling from the anode 330 to the cathode 310 travel through path 370 through, for example, a load. As battery 300 generates a current through path 370, cations travel from the anode active material 340 through electrolyte 350 and separator 360 to active material 320.

### EXAMPLES

The present invention will be described in greater detail by way of specific examples. The following examples are offered for illustrative purposes only and are not intended to limit the invention in any manner. Those of skill in the art will readily recognize a variety of noncritical parameters which can be changed or modified to yield essentially the same results. In the examples using a polyester component, the polyester is poly(ethylene terephthalate) (PET).

### Example 1

### (Synthesis of the Apparatus of the Present Invention Using a Polyimide/Polyester Blend And Hot Roll Pressing)

Polyimide/polyester blend pellets (binder pellets, 30 wt. % polyester and 70 wt. % polyimide, T_{g}, 155° C., obtained from SABIC) were milled using a two-step cryo-milling process. In the first step, the binder pellets were reduced to particles using a Cryo-Hammer-Milling apparatus (Osaka Gas Liquid Co., Ltd., Osaka, Japan). The resulting binder particles were then milled to produce micron-sized binder particle (e.g., an average particle size of 4 microns) using a cryo-beads-milling process (Aimex Corp., Japan). The micron-sized binder particles (hereinafter ER-1) were mixed with LiNi_{0.5}Mn_{0.2}Co_{0.3}O₂ (electrochemically active material (cathode active material (CAM), average particle size, 10 micron), acetylene black (electrically conductive material, average particle size 20 to 50 nanometers) in a binder:electrochemically active material:electrically conductive material ratio of 10:85:5 at a rotation speed of 16,000 rpm. The resulting mixture was agitated for 30 seconds and rested for 30 seconds for a total of ten (10) times. The mixture was dry coated on aluminum (Al) foil at a loading of 20 mg/cm² and covered with a copper foil. The dry-coated Al foil was subjected to hot roll to roll pressing at 200° C., at a load of 20 kN, and a feed rate of 0.2 meter per second to produce a film of the present invention containing a polyimide/polyester blend (70:30). FIG. 4 shows the inventive aluminum film coated with electrode material (film on the left) after the copper film (film on the right) was removed. The film formation was determined to be good for punching.

### Example 2

### (Synthesis of the Apparatus of the Present Invention Using a Polyimide/Polyester Blend With a Larger Particle Size)

Polyimide/polyester blend pellets (binder pellets, 30 wt. % polyester and 70 wt. % polyimide, T_{g}, 155° C., obtained from SABIC) was milled using a one-step cryo-milling process. The binder pellets were reduced to particles having an average particle size of 24 microns using a Cryo-Hammer-Milling apparatus (Osaka Gas Liquid Co., Ltd., Osaka, Japan). The micron-sized binder particles (hereinafter ER-2) were mixed with LiNi_{0.5}Mn_{0.2}Co_{0.3}O₂ (electrochemically active material (cathode active material (CAM), average particle size, 10 micron), acetylene black (electrically conductive material, average particle size 20 to 50 nanometers) in a binder:electrochemically active material:electrically conductive material ratio of 10:85:5 at a rotation speed of 16,000 rpm. The resulting mixture was agitated for 30 seconds and rested for 30 seconds for a total of ten (10) times. The mixture was dry coated on aluminum (Al) foil at a loading of 20 mg/cm² and covered with a copper foil. The dry-coated Al foil was subjected to hot roll to roll pressing at 200° C., at a load of 20 kN, and a feed rate of 0.2 meter per second to produce a film of the present invention containing a polyimide/polyester blend (70:30). The film formation was determined to be good for punching.

### Example 3

### (Synthesis of the Apparatus of the Present Invention Using a Polyimide or Polyimide/Polyester Blend and Hot Pressing)

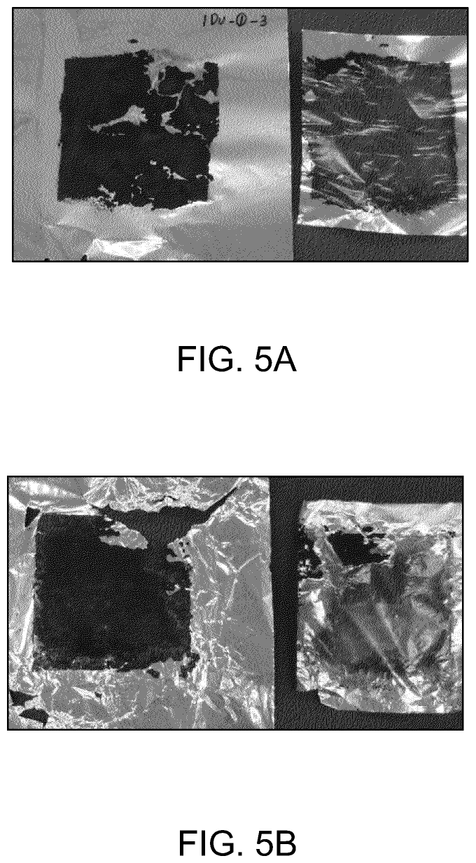

Polyimide (Ultem®, SABIC, T_{g}, 217° C. hereinafter F3SP-1) and polyimide/polyester blend pellets (binder pellets, 18 wt. % polyester and 82 wt. % polyimide, T_{g}, 155° C., hereinafter DU-1, obtained from SABIC) were milled using a two-step cryo-milling process. In the first step, the binder pellets were reduced to particles using a Cryo-Hammer-Milling apparatus (Osaka Gas Liquid Co., Ltd., Osaka, Japan). The resulting binder particles were then milled to produce micron-sized binder particle (e.g., an average particle size of 6 microns for DU and 4 microns for F3SP) using a cryo-beads-milling process (Aimex Corp., Japan). The micron-sized binder particles were mixed with LiNi_{0.5}Mn_{0.2}Co_{0.3}O₂ (electrochemically active material (cathode active material (CAM), average particle size, 10 micron), acetylene black (electrically conductive material, average particle size 20 to 50 nanometers) in a binder:electrochemically active material:electrically conductive material ratio of 10:85:5 at a rotation speed of 16,000 rpm. The resulting mixture was agitated for 30 seconds and rested for 30 seconds for a total of ten (10) times. The mixtures were dry coated on aluminum (Al) foil at a loading of 20 mg/cm² and covered with copper foil. The dry-coated Al foil for DU and F3SP were subjected to hot pressing at 220° C. and 265° C., respectively, at 15 kN for 15 sec to produce films of the present invention. FIGS. 5A and 5B shows the inventive aluminum film coated with electrode material (film on the left) after the copper film (film on the right) was removed. These films were suitable for punching out to form electrodes.

### Example 4

### (Synthesis of the Apparatus of the Present Invention Using Unmilled Polyimide)

Unmilled polyimide (Ultem®, SABIC, T_{g}, 217° C. hereinafter F3SP-0, 18 micron) was mixed with LiNi_{0.5}Mn_{0.2}Co_{0.3}O₂ (electrochemically active material (cathode active material (CAM), average particle size, 10 micron), acetylene black (electrically conductive material, average particle size 20 to 50 nanometers) in a binder:electrochemically active material:electrically conductive material ratio of 10:85:5 at a rotation speed of 16,000 rpm. The resulting mixture was agitated for 30 seconds and rested for 30 seconds for a total of ten (10) times. The mixtures were dry coated on aluminum (Al) foil at a loading of 20 mg/cm². The dry-coated Al foil was subjected to heat-roll pressing at 200° C. at 20 kN to produce a film of the present invention. The film was determined suitable for punching to produce electrodes.

### Example 5

### (Testing of the Apparatus of the Present Invention)

To check the compatibility of the thin films from Examples 1-4, the electrical conductivity (σ) of the films were measured using a 2-probe technique. For example, two-probes (contacts) were contacted on the thin film and the voltage was measured while applying a current between the two probes. Table 1 lists properties of the films. From the testing, it was determined that hot-roll pressed films had a higher conductivity than hot pressed films.

TABLE 1

| | General | | | | | |
|---|---|---|---|---|---|---|
| Properties | Criteria | ER-1 | DU-1 | F3SP-1 | ER-2 | F3SP-0 |
| Diameter(mm) | | 10 | | | | |
| Thickness(microns) | 60-100 | 78 | 70 | 75 | 94 | 105 |
| Loading(mg/cm²) | 15-50 | 19.1 | 20.2 | 20.7 | 2105 | 27.6 |
| Density(g/cm³) | | 2.4 | 2.9 | 2.8 | 2.3 | 2.6 |
| Porosity*(%) | 20-50 | 32 | 20 | 23 | 36 | 26 |
| σ(S/cm × 10⁻²) | >1 × 10⁻² | 4.7 | 1.3 | 20 | 1.1 | 3.1 |

*Calculated using Porosity = (1 − dᵣₑₐₗ/d_{ideal}) × 100; d_{ideal} was calculated with d_{CAM}(4.8), d_{AB}(2.2) and d_{binder}(1.27) [g/cm³].

### Example 6

### (Comparative Apparatus (PVDF Electrode))

A wet PVDF electrode having was prepared using conventional slurry methodology. PVDF was dissolved in a solvent (N-methyl-2-pyrrolidone, NMP) and mixed with CAM and AB. The CAM:AB:PVDF ratio was 93:5:2. The solvent was evaporated and the electrode dried at 120° C. until dry (12 to 24 hours) to produce the comparative apparatus (wet PVDF). “Wet PVDF” refers to the method of preparing the electrode having PVDF as the binder. Table 2 lists the properties of the comparative wet PVDF thin film.

TABLE 2

| Properties | PVDF | PVDF-1 | PVDF-2 | PVDF-3 |
|---|---|---|---|---|
| Diameter(mm) | 10 | | | |
| Thickness(microns) | 68 | 49 | 41 | 39 |
| Loading(mg/cm²) | 20.1 | 13.3 | 11.9 | 11.0 |
| Density(g/cm³) | 3.0 | 3.5 | 3.2 | 3.5 |
| Porosity(%)* | 32 | 24 | 28 | 16 |
| σ(S/cm × 10⁻²) | 1.4 | 2.7 | 3.1 | 1.4 |

Porosity was calculated using the formula: Porosity = (1-dᵣₑₐₗ/d_{ideal}) × 100; d_{ideal} was calculated with d_{CAM}(4.8), d_{AB}(2.2) and d_{PVDF}(1.79) [g/cm³].

### Example 7

### (Synthesis of the Comparative Dry PVDF Apparatus)

PVDF in three different amounts (10 wt. %, 5 wt. % and 3 wt. %, Kynar® HSV 900, Arkema, France, particle size 2-40 microns, melting temperature 162-172° C.) were mixed with LiNi_{0.5}Mn_{0.2}Co_{0.3}O₂ (electrochemically active material (cathode active material (CAM), average particle size, 10 micron), acetylene black (electrically conductive material, average particle size 20 to 50 nanometers) in a PVDF binder:electrochemically active material:electrically conductive material ratio of 10:85:5 (10 wt. % PVDF), 5:90:5 (5 wt. % PVDF) and 3:92:5 (3 wt. % PVDF) at a rotation speed of 16,000 rpm. The resulting mixture was agitated for 30 seconds and rested for 30 seconds for a total of ten (10) times. The mixture was dry coated on aluminum (Al) foil at a loading of 20 mg/cm² and covered with a copper foil. The dry-coated Al foil was subjected to roll-to-roll press at 200° C. at 20 kN to produce a three dry coated films, PVDF-1 (10 wt. % dry PVDF), PVDF-2 (5 wt. % dry PVDF), and PVDF-3 (3 wt. % dry PVDF). Table 2 lists the properties of the dry PVDF thin films.

### Example 8

### (Electrochemical Testing of Apparatus of the Present Invention and Comparative Apparatus)

Films of the present invention (ER-1 cathode from Example 1, ER-2 from Example 2, and F3SP-0 cathode from Example 5) were punched-out and dried at 120° C. under vacuum for 10 hours. The dry PVDF-1, dry PVDF-2, dry PVDF-3 cathodes from Example 7 were punched-out and dried at 120° C. under vacuum for 10 hours. The wet PVDF electrode from Example 6 was used as prepared. Each electrode was placed in an electrochemical test cell positioned in a glove box having a H₂O content of less than 0.1 ppm, and an oxygen content of less than 1 ppm. The components of the inventive apparatus included the cathode prepared as described in Examples 1, 2, and 4-7, an anode (Li Foil, diameter 10 mm, and thickness of 200 microns), a polyethylene membrane and glass mat separator, and an electrolyte (1 M LIPF₆ in a 3:7 v/v of ethylene carbonate and methylethyl carbonate). Charge-discharge testing, then EIS testing, then combined C-rate and cycling performance testing at 25° C. were performed on each apparatus.

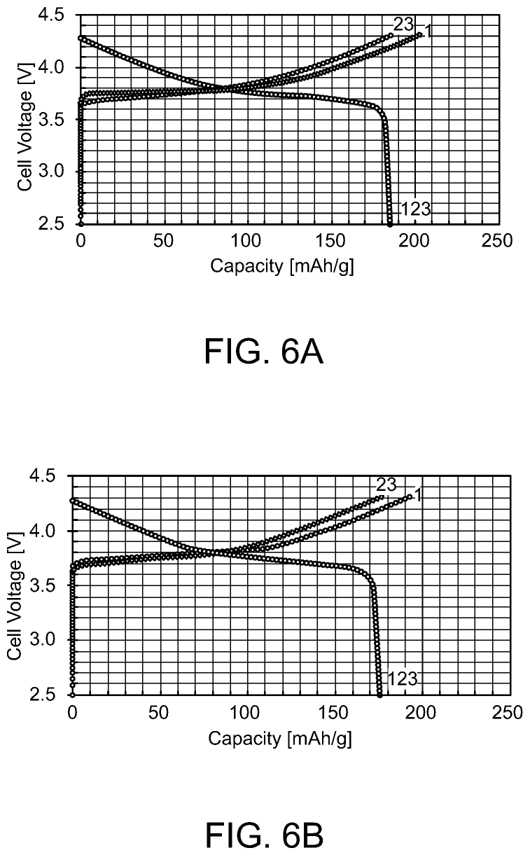

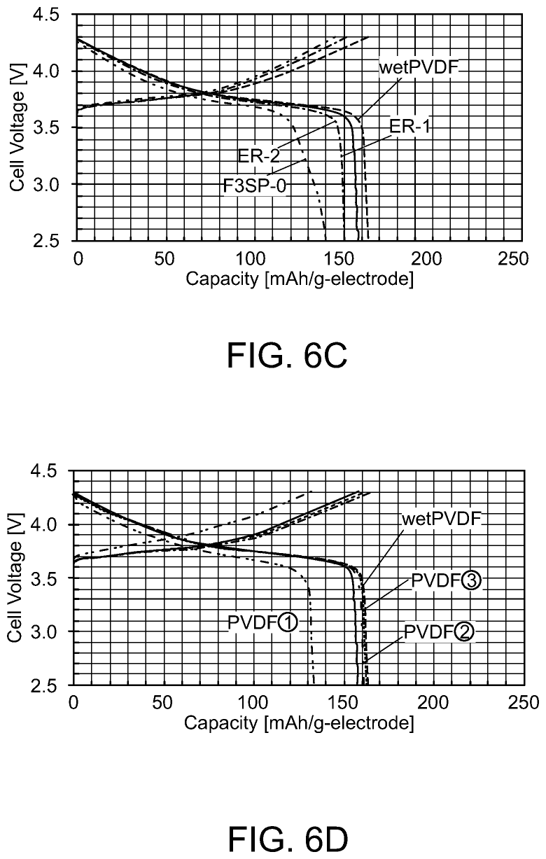

Charge-discharge testing. Charge-discharge testing was performed for 3 cycles under the following conditions: Charge: Constant charge (CC)-constant voltage (CV) at 0.1 C-rate (C) to 4.3V taper to 0.05 C; Discharge: CC at 0.1 C to 2.5V, where 1 C=170 mAh/g for the electrochemically active agent. FIG. 6A is a graphical illustration of the charge-discharge testing at 0.2 C and 25° C. of the inventive apparatus (ER-1 cell), FIG. 6B is a graphical illustration of the charge-discharge testing at 0.2 C and 25° C. of the comparative apparatus (wet PVDF cell), FIG. 6C is a graphical illustration of the charge-discharge testing at 0.2 C and 25° C. of the inventive apparatus (ER-1 cell, ER-2 cell and PVDF-0 Cell) and the comparative apparatus (wet PVDF cell), and FIG. 6D is a graphical illustration of the charge-discharge testing at 0.2 C and 25° C. of the inventive apparatus (ER-1 cell) and the comparative apparatus (wet PVDF cell, dry PVDF-1, dry PVDF-2, and dry PVDF-3). The inventive apparatus ER-1 cells showed the best charge-discharge performance as compared to the wet PVDF cell and the three dry PVDF cells. Notably, the discharge capacity of the ER-1 (185 mAh/g) was 5% larger than that of the comparative apparatus (wet PVDF cell, 175 mAh/g). Table 3 lists the capacity and efficiency of the ER-1 cell and the wet PVDF electrochemical cell.

TABLE 3

| | ER-1 | | | wetPVDF | | |
|---|---|---|---|---|---|---|
| | Capacity(mAh/g) | | Eff. | Capacity (mAh/g) | | Eff. |
| Cycle | Charge | Discharge | (%) | Charge | Discharge | (%) |
| 1 | 202.7 | 184.9 | 91.23 | 192.5 | 175.3 | 91.09 |
| 2 | 185.6 | 185.1 | 99.74 | 176.2 | 175.5 | 99.64 |
| 3 | 185.4 | 184.9 | 99.73 | 176.2 | 175.4 | 99.58 |

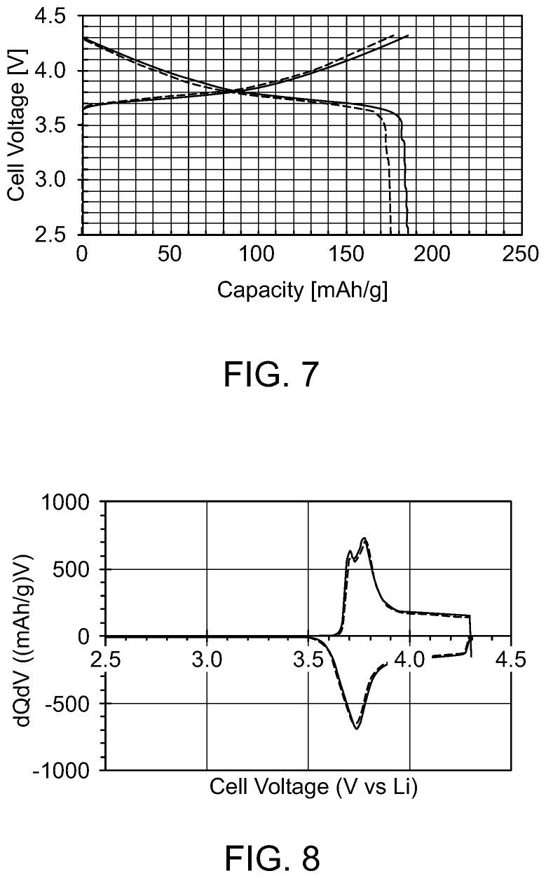

FIG. 7 is a graphical illustration of the charge-discharge profile for the second discharge-charge cycle at 0.1 C and 25° C. for the inventive apparatus (ER-1, solid line) and the comparative apparatus (wet PVDF, dotted line). The upward sloping lines are charging data and the downward sloping lines are discharging data. It was determined that the charge profile of the inventive apparatus (ER-1) had a slightly lower voltage (50 mV lower at a capacitance of 150 mAh/g, FIG. 7) than that of the comparative apparatus (wet PVDF cell), and the discharge profile of the inventive ER-1 cell had a slightly higher voltage (21 mV higher at a capacitance of 150 mAh/g, FIG. 7) than that of the wet PVDF cell. Thus, the overpotential of the inventive ER-1 cell was smaller than that of the wet PVDF cell.

The differential capacity was calculated at each 5 mV in the charge-discharge curve (FIG. 7). FIG. 8 is a graphical illustration of the differential capacity analysis (dQ/dV curves) during the second discharge cycle at 0.1 C and 25° C. for the inventive apparatus (ER-1, solid line) and the comparative apparatus (wet PVDF, dashed line). The lines in the positive area are charge curves and the lines in the negative area are discharge curves. The dQdV analyses of each cell were similar. From these analyses, it was determined that the electrochemically active material worked more effectively in the inventive apparatus (ER-1) than in the comparative apparatus (wet PVDF cell). The inventive apparatus also did not have any solvent damage.

Internal Resistance. During the charge-discharge test, the internal resistance of each cell was checked by measuring the internal resistance (iR) drop at the beginning of discharge (after 1 sec discharge). The resistance of the inventive apparatus (ER-1 cell (19Ω)) was 48% lower than that of the comparative apparatus (wet PVDF cell (36Ω)).

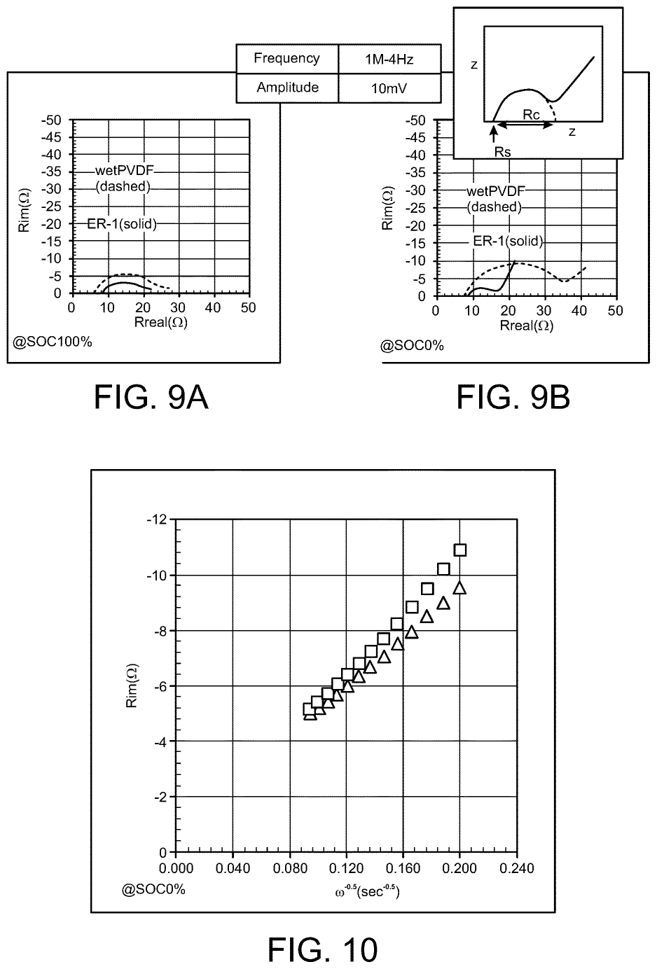

Electrochemical Impedance Spectroscopy (EIS) was performed using a frequency of 1 mHz to 4 Hz and a delta voltage equal to 10 mV at 0% and 100% state of charge (SOC). FIGS. 9A and 9B are EIS spectra of the inventive apparatus (ER-1 cell) and the comparative apparatus (wet PVDF cell). Referring to FIG. 9, the EIS of the inventive apparatus (ER-1 cell, solid line) showed a smaller semi-circle (bottom semi-circle) than the comparative apparatus (wet PVDF cell, top semi-circle, dashed line). The solution resistance (Rsol) of the inventive apparatus (ER-1 cell) was slightly larger than the comparative apparatus (wet PVDF cell) (8.5Ω vs. 6.2Ω at state of charge (SOC) of 100% (FIG. 9A) and 8.6Ω vs. 7.5Ω at 0% SOC (FIG. 9B)). However, the charge-transfer resistance (R_{ct}) of the inventive apparatus (ER-1 cell, 7.0Ω at 0% SOC) was smaller than that of the comparative apparatus (wet PVDF cell, 28.3 at 0% SOC). This result correlated with the internal resistance results.

Lithium-ion diffusion coefficient (D_{Li}⁺) calculation. The lithium-ion diffusion coefficients of the inventive apparatus (ER-1 cell) and the comparative apparatus (wet PVDF cell) were calculated using Eq. 1. The DLit of the inventive apparatus (ER-1 cell) was slightly smaller than that of the comparative apparatus (wet PVDF cell) (2.0×10⁻¹¹ cm²/see vs. 3.1×10⁻¹¹ cm²/sec). FIG. 10 depicts Rᵢₘ^{-ω-0.5} plots for the inventive apparatus (ER-1 cell, square monikers) and the comparative apparatus (wet PVDF cell, triangle monikers).

$${D}_{Li}^{+} = \frac{{R}^{2} {T}^{2}}{2 {A}^{2} {n}^{4} {F}^{4} {C}^{2} {σ}^{2}} , \qquad Eq . 1$$

where
R: ideal gas constant (8.314 J mol⁻¹ K⁻¹=8.314 A V sec mol⁻¹ K⁻¹)
T: absolute temperature (298.15K)
A: the surface area of the active material (0.785 cm²)
n: transferred electron number during the electrochemical reaction (1)
F: Faraday constant (96,485 C mol⁻¹=96,485 A sec mol⁻¹).
C: Li+ concentration (0.001 mol cm⁻³)
σ: Warburg coefficient, calculated from Rim-w^{-0.5} plots (A V⁻¹ sec^{-0.5}).

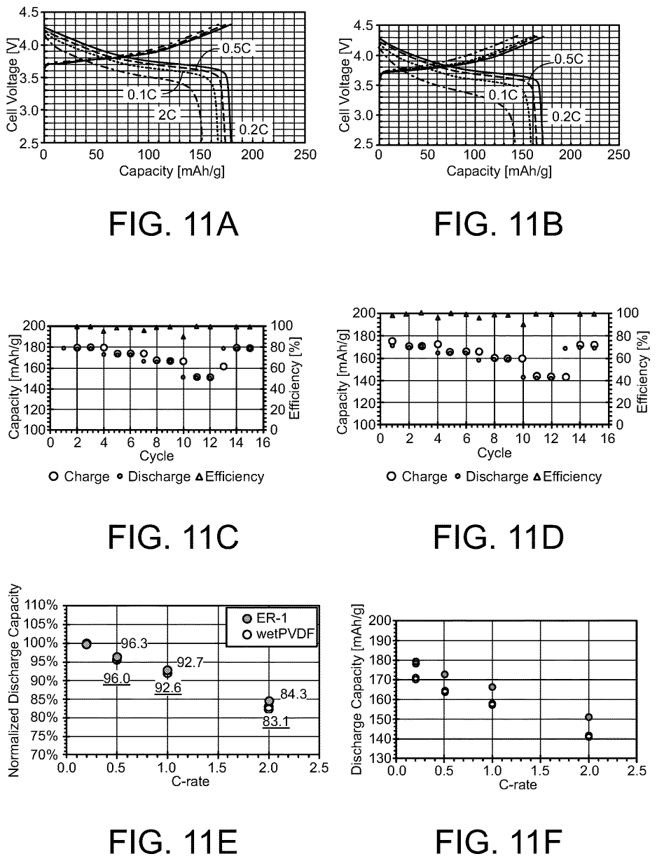

Combined C-rate and Cycling performance was performed under the following conditions:
charge: CC-CV (constant charge-constant voltage) at 0.2 C-rate (C) to 4.3 V taper to
0.05 C; discharge: CC at 0.2 C to 2.5 V for 3 cycles;
CC at 0.5 C to 2.5 V for 3 cycles;
CC at 1 C to 2.5V for 3 cycles;
CC at 2 C to 2.5V for 3 cycles, and
CC at 0.2 C to 2.5V for 3 cycles.
   FIGS. 11A, 11B, 11C, 11D, 11E, and 11F depict C-rate and Cycling performance for the inventive apparatus (ER-1 cell) and the comparative apparatus (wet PVDF cell). FIGS. 11A and 11B depict cell voltage vs. capacity plots for the inventive apparatus (ER-1 cell) and the comparative apparatus (wet PVDF cell), respectively at 2 C, 1 C, 0.5 C and 0.2 C. FIGS. 11C and 11D depict capacity vs. cycle plots for the inventive apparatus (ER-1 cell) and the comparative apparatus (wet PVDF cell), respectively. In these plots, the open circle monikers are charge, the solid circle monikers are discharge, and the triangle monikers are efficiency. FIGS. 10E and 10F depict discharge capacity vs. C-rate plots for the inventive apparatus (ER-1 cell, solid circle monikers) and the comparative apparatus (wet PVDF cell, open circle monikers), respectively. FIG. 11E is normalized charge capacity and FIG. 11F is discharge capacity (mAh/g). From the data, it was determined that the inventive apparatus (ER-1 cell) and the comparative apparatus (wet PVDF cell) both had good C-rate and cycling performance. It was also determined that the C-rate performance of the inventive apparatus (ER-1 cell) and the comparative apparatus (wet PVDF cell) were similar. Notably, a higher normalized discharge capacity at each C-rate was observed for the inventive apparatus (ER-1 cell) versus the comparative apparatus (wet PVDF cell). The inventive apparatus (ER-1 cell) maintained a capacity of 99.7% (15th/1st) after the cycling test while the comparative apparatus (wet PVDF cell) maintained a slightly lower capacity of 99.0%.

In summary, the inventive apparatuses of the present invention showed extremely good initial charge-discharge performance based on the lower internal resistance than that of the conventional wet-process PVDF cell. The internal resistance was dominated with lithium-ionic and electronic behavior; thus, the electronic behavior of the inventive apparatus was more dominant than the comparative apparatus. Therefore, the binders of the present invention were determined to be a suitable substitute for PVDF and therefore other per- and poly fluorinated substances (PFAS).

Although embodiments of the present application and their advantages have been described in detail, it should be understood that various changes, substitutions, and alterations can be made herein without departing from the scope of the appended claims. Moreover, the scope of the present application is not intended to be limited to the particular embodiments of the composition of matter, methods and steps described in the specification. As one of ordinary skill in the art will readily appreciate from the above disclosure, compositions of matter, methods, or steps, presently existing or later to be developed that perform substantially the same function or achieve substantially the same result as the corresponding embodiments described herein can be utilized. Accordingly, the appended claims are intended to include within their scope such compositions of matter, methods, or steps.

1. An apparatus, comprising:
an electrode; and
an active material powder-coated on a surface of the electrode, wherein the active material comprises:
an electrochemically active component; and
a binding compound for adhering the active material to the electrode, wherein the binding compound comprises polyimides, polyethyleneimines, polyesters, polyamides, polyurethanes, acrylics, polyolefins, polyvinylchloride, polystyrene, polyketones, copolymers thereof, and conjugated polymers, including n-type polymers and p-type polymers, or blends thereof.

2. The apparatus of claim 1, wherein the binding compound comprises a polyimide or a polyimide and polyester blend.

3. The apparatus of claim 2, wherein the binding compound has a glass transition temperature ranging from 50° C. to 250° C.

4. The apparatus of claim 2, wherein the binding compound comprises a minimum of 40 wt. % polyimide and a maximum of 60 wt. % polyester.

5. The apparatus of claim 4, wherein the polyimide is polyetherimide and the polyester is poly(ethylene terephthalate), poly(butylene terephthalate), or a mixture thereof.

6. The apparatus of claim 2, wherein the electrochemically active component comprises tin, lithium, cobalt, manganese, aluminum, tin, indium gallium, titanium, vanadium, chromium, iron, nickel, oxides thereof, phosphates thereof, fluorophosphates thereof, nitrides thereof, or combinations thereof.

7. The apparatus of claim 2, wherein the active material further comprises an electrically conductive material comprising graphite, carbon, carbon black, acetylene black, carbon nanotubes, carbon nanoribbons, carbon fibers, carbon nanofiber, graphene, mesophase carbon microbeads, SnO₂, SnO, TiO₂, Li₄Ti₅O₁₂, LiTi₂O₄, SiO₂, silicon, germanium, coke, metal particles, or combinations thereof.

8. The apparatus of claim 7, wherein the active material comprises from 60 to 98% by weight of the electrochemically active component, from 0% to 20% by weight of the electrically conductive material, and from 2% to 40% by weight of the binding compound.

9. The apparatus of claim 1, wherein the electrode is a cathode, an anode, or both.

10. A battery comprising the apparatus of claim 1.

11. A method of making the apparatus of claim 1, the method comprising:
mixing an electrochemically active component, a binding compound comprising polyimides, polyethyleneimines, polyesters, polyamides, polyurethanes, acrylics, polyolefins, polyvinylchloride, polystyrene, polyketones, copolymers thereof, and conjugated polymers, including n-type polymers and p-type polymers, or a blend thereof, and, optionally, an electrically conductive material to provide an active material; and
adhering the active material to an outer surface of an electrode in the absence of a solvent.

12. The method of claim 11, wherein adhering the active material comprises a hot-pressing process, a hot rolling process, or a combination thereof.

13. The method of a claim 12, wherein each constituent component of the active material has an average particle size ranging from 1 μm to 30 μm.

14. The method of claim 11, further comprising incorporating the apparatus in a battery.

15. The use of the apparatus of claim 1 in a battery.

16. The apparatus of claim 2, wherein the binding compound comprises a minimum of 70 wt. % to 75 wt. % polyimide and 25 wt. % to 30 wt. % polyester.

17. The apparatus of claim 2, wherein the electrochemically active component comprises oxides of lithium, cobalt, manganese, and nickel.

18. The apparatus of claim 2, wherein the active material further comprises acetylene black.

19. The apparatus of claim 2, wherein:
the binding compound comprises a minimum of 70 wt. % to 75 wt. % polyimide and 25 wt. % to 30 wt. % polyester;
the electrochemically active component comprises oxides of lithium, cobalt, manganese, and nickel; and
the active material further comprises acetylene black.
